(19) United States
(12) Patent Application Publication
(10) Pub. No.: US 2009/0153913 A1
(43) Pub. Date: Jun. 18, 2009

(54) Method For Providing Enhancement With An Imaging Apparatus

(76) Inventors: William Joseph Butler, JR., Walton, KY (US); Anthony Michael King, Lexington, KY (US); Mark Eric Miller, Versailles, KY (US)

Correspondence Address: TERRY L. GRIESHABER;VETERINARY CENTER FOR SKIN DISORDERS, 820 OGDEN AVENUE, LISLE, IL, 60532, US

(21) Appl. No.: 12/006,751

(22) Filed: Dec. 18, 2007

(51) Int. Cl. H04N 1/00

(52) U.S. Cl. 358/447

(57) ABSTRACT

A method for providing image enhancement with an imaging apparatus includes imaging a target a plurality of times to generate a corresponding plurality of image data sets; averaging the image data sets on a pixel-by-pixel basis to generate a final image data set corresponding to the target; and generating an output image of the target based on the final image data set.

### CROSS-REFERENCE TO RELATED APPLICATIONS

None.

### MICROFICHE APPENDIX

None.

### GOVERNMENT RIGHTS IN PATENT

None.

### BACKGROUND OF THE INVENTION

1. Field of the Invention

The present invention relates to imaging, and, more particularly, to a method for providing image enhancement with an imaging apparatus.

2. Description of the Related Art

A typical scanner generates an image of a document through a single exposure scan. Due to the nature of scanners, image enhancements are limited to performing operations on the single exposure file of the scanned image. Thus, enhancements on scanned images are performed after a single scan is taken. Functions such as sharpening, blurring, de-speckle, contrast, and brightness are thus limited to working with the single exposure file that may have limitations based on the original scan conditions and electrical/optical noise.

### SUMMARY OF THE INVENTION

The present invention provides image enhancement with an imaging apparatus through averaging of a plurality of image data sets corresponding to an imaged target.

The invention, in one form thereof, is directed to a method for providing image enhancement with an imaging apparatus. The method includes imaging a target a plurality of times to generate a corresponding plurality of image data sets; averaging the image data sets on a pixel-by-pixel basis to generate a final image data set corresponding to the target; and generating an output image of the target based on the final image data set.

The invention, in another form thereof, is directed to an imaging apparatus. The imaging apparatus includes a camera scan system. A controller is communicatively coupled to the camera scan system. The controller executes program instructions to perform the acts of: imaging a target a plurality of times to generate a corresponding plurality of image data sets; averaging the image data sets on a pixel-by-pixel basis to generate a final image data set corresponding to the target; and generating an output image of the target based on the final image data set.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a diagrammatic depiction of an imaging system embodying the present invention.

FIG. 2 is a diagrammatic representation of a camera scan system in the imaging apparatus of the imaging system of FIG. 1.

FIG. 3 is a flowchart of a method for providing image enhancement with an imaging apparatus, in accordance with an aspect of the present invention.

FIG. 4 is a graph showing the variation of luminance intensity for a single pixel of a pixel area taken over 64 exposures.

Corresponding reference characters indicate corresponding parts throughout the several views. The exemplifications set out herein illustrate an embodiment of the invention, in one form, and such exemplifications are not to be construed as limiting the scope of the invention in any manner.

### DETAILED DESCRIPTION OF THE INVENTION

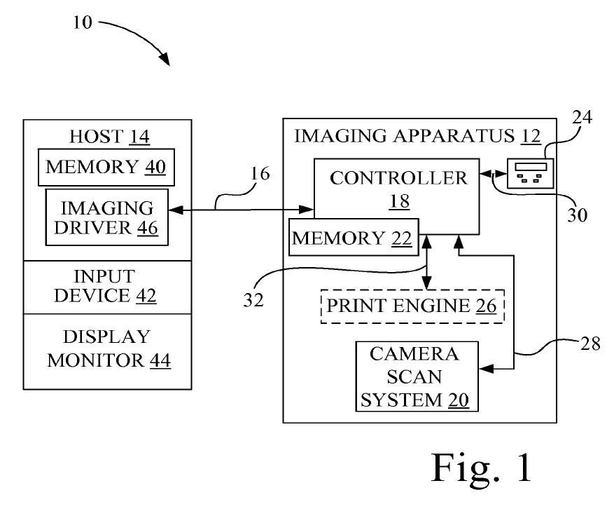

Referring now to the drawings and particularly to FIG. 1, there is shown a diagrammatic depiction of an imaging system 10 embodying the present invention.

Imaging system 10 may include an imaging apparatus 12 and a host 14. Imaging apparatus 12 communicates with host 14 via a communications link 16. As used herein, the term “communications link” is used to generally refer to structure that facilitates electronic communication between multiple components, and may operate using wired or wireless technology. Imaging apparatus 12 may communicate with host 14 via a standard communication protocol, such as for example, universal serial bus (USB), Ethernet or IEEE 802.xx.

In the exemplary embodiment of FIG. 1, imaging apparatus 12 includes a controller 18, a camera scan system 20, memory 22, and a user interface 24. Optionally, as indicated by dashed lines, imaging apparatus 12 may also include a print engine 26 for performing a printing function. Print engine 26 may accommodate, for example, ink jet printing, electrophotographic printing, thermal transfer printing, etc. Thus, in the context of the present invention, it is to be understood that imaging apparatus 12 may be a scanner, a scanner-copier, a scanner-printer-copier, and may include other functionality, such as facsimile capability to form an All-In-One (AIO) machine.

Controller 18 includes a processor unit and associated memory 22, and may be formed as one or more Application Specific Integrated Circuits (ASIC). Memory 22 may be, for example, random access memory (RAM), read only memory (ROM), and/or non-volatile RAM (NVRAM). Alternatively, memory 22 may be in the form of a separate electronic memory (e.g., RAM, ROM, and/or NVRAM), a hard drive, a CD or DVD drive, or any memory device convenient for use with controller 18. Controller 18 is a scanner controller, and in some embodiments may be a combined printer and scanner controller.

In the present embodiment, controller 18 communicates with camera scan system 20 via a communications link 28. User interface 24 is communicatively coupled to controller 18 via a communications link 30. Optional print engine 26 is communicatively coupled to controller 18 via a communications link 32. Controller 18 serves to operate camera scan system 20 and process data obtained via camera scan system 20. In addition, optionally, controller 18 executes program instructions to process print data and to operate print engine 26 during printing.

Host 14, which may be optional, may be, for example, a personal computer, including memory 40, such as RAM, ROM, and/or NVRAM, an input device 42, such as a keyboard, and a display monitor 44. Host 14 further includes a processor, input/output (I/O) interfaces, and at least one mass data storage device, such as a hard drive, a CD-ROM and/or a DVD unit.

Host 14 may include in its memory a software program including program instructions that function as an imaging driver 46, e.g., scanner and/or printer driver software, for imaging apparatus 12. Imaging driver 46 is in communication with controller 18 of imaging apparatus 12 via communications link 16. Imaging driver 46 facilitates communication between imaging apparatus 12 and host 14.

In some circumstances, it may be desirable to operate imaging apparatus 12 in a standalone mode. In the standalone mode, imaging apparatus 12 is capable of functioning without host 14. Accordingly, all or a portion of imaging driver 46, or a similar driver, may be located in controller 18 of imaging apparatus 12 so as to accommodate scanning, copying, and/or printing operations being handled by imaging apparatus 12 when operating in the standalone mode.

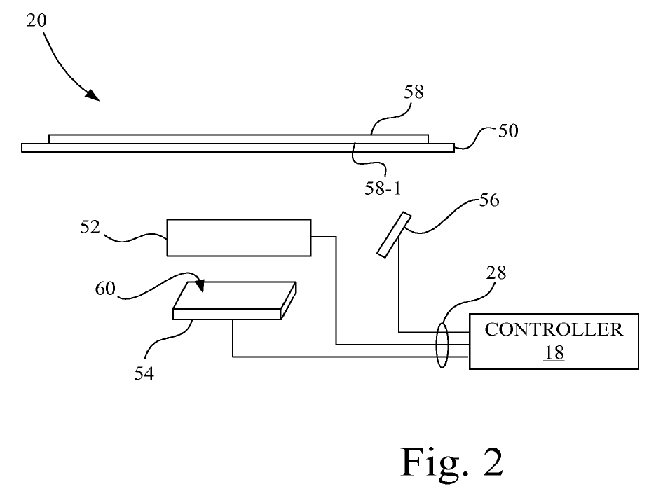

Referring to FIG. 2, there is shown a diagrammatic representation of an embodiment of camera scan system 20. Camera scan system 20 includes a document support 50, a lens system 52, a sensor array 54 and an illumination source 56. Document support 50 is a transparent member, e.g., glass, for supporting a target 58, e.g., a document, etc., to be scanned. Lens system 52, sensor array 54 and illumination source 56 are communicatively coupled to controller 18 via communication link 28.

A surface 58-1 of target 58 to be scanned is positioned to face lens system 52 and illumination source 56. Where target 58 is a document sheet, surface 58-1 may include text, pictures, graphics, or a combination thereof. Controller 18 operates lens system 52 to provide auto focusing, and image enlargement/reduction. Controller 18 operates illumination source 56 to illuminate surface 58-1 of target 58, and receives image data representing surface 58-1 of target 58 from sensor array 54.

Sensor array 54 includes a plurality of sensor elements arranged in a two-dimensional array, with each sensor element being referred to herein as a pixel and the plurality of sensor elements being referred to herein as a pixel area 60. All or a portion of pixel area 60 may be used in representing a full image of target 58.

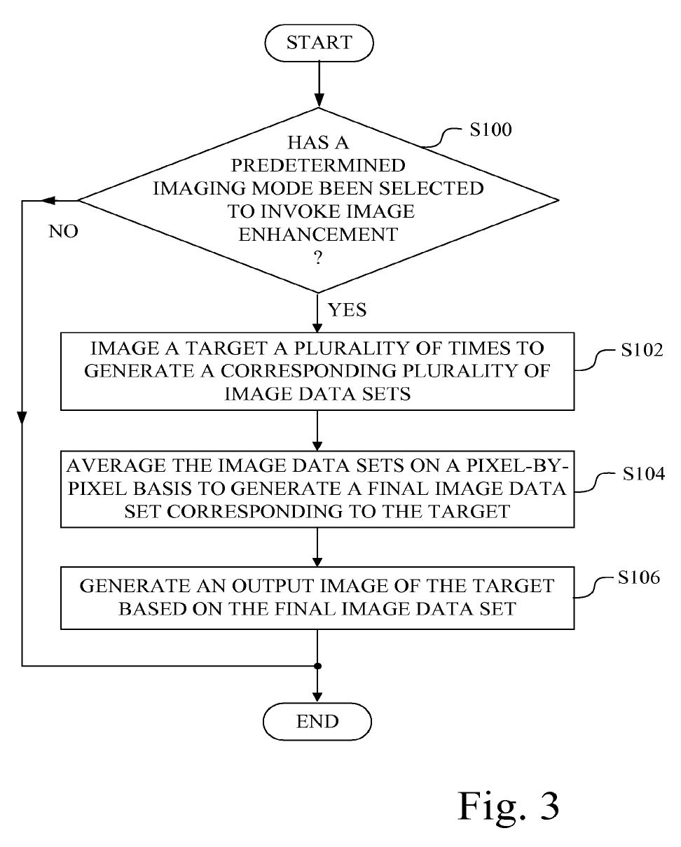

Referring to FIG. 3, there is show a flowchart of a method for providing image enhancement with an imaging apparatus, in accordance with an aspect of the present invention. The method may be implemented, for example, as program instructions executed by controller 18 of imaging apparatus 12.

At act S100, it is determined whether a predetermined imaging mode of a plurality of imaging modes relating to image quality has been selected. Such selection may be made, for example, by an input of a user to user interface 24.

The plurality of imaging modes may include, for example, a fast scan at a low quality up through higher quality text or photo modes. Examples of the higher quality modes include a photo mode (e.g., better or best) and a text enhancement mode. However, it may not be desired to perform image enhancement in accordance with the present invention in all modes due to potential throughput rate reductions. Thus, in the present embodiment, the image enhancement of the present invention may be invoked only when a predetermined imaging mode of the plurality of imaging modes is selected by the user. For example, the predetermined imaging mode may be the text enhancement mode and/or a photo mode.

It noted that act S100 is optional.

At act S102, target 58 is imaged a plurality of times to generate a corresponding plurality of image data sets. The plurality of image sets may be temporarily stored, for example, in memory 22. The data for each pixel of pixel area 60 in each of the plurality of image data sets may include, for example, a luminance value.

Each image data set of the plurality of image data sets relates to a separate exposure of sensor array 54 to target 58. Thus, in camera scan system 20 of imaging apparatus 12, imaging is performed by exposure of sensor array 54 to target 58 a plurality of times to collect the plurality of image data sets. In some embodiments, it may be desired to vary the exposure level during the plurality of exposures. Accordingly, controller 18 may control illumination source 56 of camera scan system 20 to vary an exposure level, e.g., the illumination intensity, for at least some exposures of the plurality of times that sensor array 54 collects the plurality of image data sets respectively corresponding to the multiple imaging of target 58.

At act S104, the plurality of image data sets is averaged on a pixel-by-pixel basis to generate a final image data set corresponding to target 58.

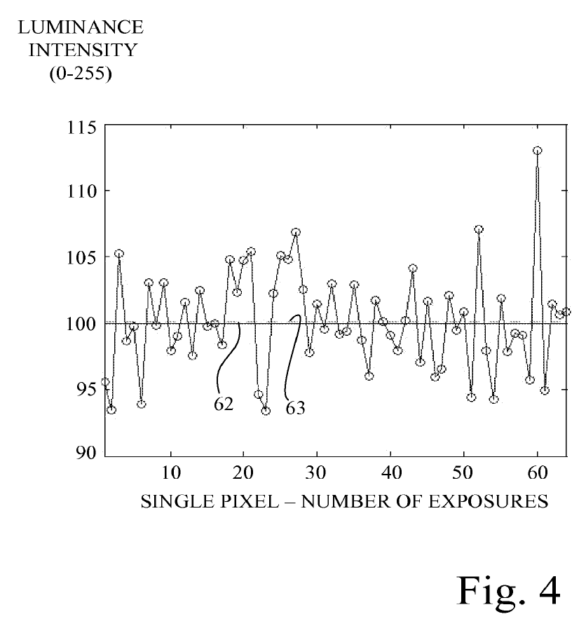

The luminance values provided by sensor array 54 may be modeled by a Normal or Gaussian distribution. Temporal noise characteristics such as dark current shot noise and photon shot noise cause the luminance values to vary from the “true” value within the plurality of image data sets, as illustrated in FIG. 4.

FIG. 4 shows the variation of luminance intensity for a single pixel of the pixel area 60 taken over 64 exposures (i.e., target 58 imaged 64 times). In this example, the true value is 100 (solid line 62). If only the first image (first exposure) for the current pixel was used, the sensed value would have been a luminance intensity of 96, which is four counts away from the true value. However, through averaging the 64 exposures for the current pixel, the average (mean) value is 100.14 (dashed line 63), which approaches the true count. Since the Gaussian distribution is evenly and symmetrically centered about its mean, the average of the plurality of image data sets on a pixel-by-pixel basis converges to the true mean for each respective pixel of pixel area 60 with an ever increasing number of sample images.

Thus, by capturing several images of target 58 and averaging the corresponding image data sets together on a pixel-by-pixel basis, the noise levels are significantly reduced over that of a given single image. Accordingly, the more image data sets generated and averaged, the more the noise is reduced. This relationship may be expressed as a noise level that is proportional to the square root of the number of images taken and averaged together, by the equation:

ANL=[(1/√n)*SENL],

wherein:
ANL is the averaged noise level;
n is the number of images taken (i.e., the number of image data sets); and
SENL is the single image (i.e., exposure) noise level.
   Therefore, for example, imaging four times (i.e., taking four exposures) and performing the averaging would reduce the noise level by one-half, imaging sixteen times (i.e., taking sixteen exposures) would reduce the noise level by three-fourths, and so on.

At act S106, an output image of target 58 is generated based on the final image data set established at act S104. The output image may be stored in a memory, such as memory 22 of imaging apparatus 12, and retrieved later for further processing. Also, the output image may be displayed on a display screen, such as that associated with user interface 24 or display monitor 44, and/or printed by print engine 26.

While the embodiment described above for implementing the present invention is an imaging apparatus including a camera scan system, it is contemplated that the principles of the present invention may be applied to scanners that utilize conventional linear sensor scan bars.

While this invention has been described with respect to an embodiment of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for providing image enhancement with an imaging apparatus, comprising:
imaging a target a plurality of times to generate a corresponding plurality of image data sets;
averaging said image data sets on a pixel-by-pixel basis to generate a final image data set corresponding to said target; and
generating an output image of said target based on said final image data set.

2. The method of claim 1, wherein said imaging is performed using a camera scan system by exposure of a sensor array to said target said plurality of times.

3. The method of claim 2, wherein an exposure level is varied for at least some exposures of said plurality of times that said sensor array is exposed.

4. The method of claim 1, wherein said imaging apparatus is operable in a plurality of imaging modes relating to imaging quality, said method being invoked only when a predetermined imaging mode of said plurality of imaging modes is selected by a user.

5. The method of claim 4, wherein said predetermined imaging mode is one of a text enhancement mode and a photo mode.

6. The method of claim 1, wherein said output image is stored in a memory.

7. The method of claim 1, wherein said output image is displayed on a display screen.

8. The method of claim 1, wherein said output image is printed by a print engine.

9. An imaging apparatus, comprising:
a camera scan system; and
a controller communicatively coupled to said camera scan system, said controller executing program instructions to perform the acts of:
imaging a target a plurality of times to generate a corresponding plurality of image data sets;
averaging said image data sets on a pixel-by-pixel basis to generate a final image data set corresponding to said target; and
generating an output image of said target based on said final image data set.

10. The imaging apparatus of claim 9, wherein said camera scan system includes a sensor array, and wherein said imaging is performed by exposure of said sensor array to said target said plurality of times.

11. The imaging apparatus of claim 10, wherein said camera scan system includes an illumination source, said controller controlling said illumination source to vary an exposure level for at least some exposures of the plurality of times that said sensor array is exposed.

12. The imaging apparatus of claim 9, further comprising an user interface communicatively coupled to said controller, said imaging apparatus being operable in a plurality of imaging modes relating to imaging quality, and wherein the acts of imaging and averaging are preformed only when a predetermined imaging mode of said plurality of imaging modes is selected by a user.

13. The imaging apparatus of claim 12, wherein said predetermined mode is one of a text enhancement mode and a photo mode.

14. The imaging apparatus of claim 9, further comprising a memory communicatively coupled to controller, and wherein said controller executes program instructions to store said output image in said memory.

15. The imaging apparatus of claim 9, further comprising a display screen communicatively coupled to said controller, and wherein said controller executes program instructions to display said output image on said display screen.

16. The imaging apparatus of claim 9, further comprising a print engine communicatively coupled to said controller, and wherein said controller executes program instructions to control said print engine to print said output image.
